(19) United States
(12) Patent Application Publication
(10) Pub. No.: US 2017/0092964 A1
(43) Pub. Date: Mar. 30, 2017

(54) FUEL CELL MODULE INCLUDING HEAT EXCHANGER AND METHOD OF OPERATING SUCH MODULE

(71) Applicant: General Electric Company, Schenectady, NY (US)

(72) Inventors: Darren Bawden Hickey, Halfmoon, NY (US); Keith Garrette Brown, Clifton Park, NY (US)

(21) Appl. No.: 14/867,391

(22) Filed: Sep. 28, 2015

(51) Int. Cl. H01M 8/04007; H01M 8/2484

(52) U.S. Cl. CPC H01M 8/04007; H01M 8/2484

(57) ABSTRACT

A fuel cell block for use in a fuel cell module includes a fuel cell. A heat exchanger coupled to the fuel cell includes a first heat exchange component, a second heat exchange component, and a casing defining an interior space. An air inlet pipe, a fuel inlet pipe, an air outlet pipe, and a fuel outlet pipe each channel fluid and at least partially extend through the interior space. A manifold includes a first surface and a second surface opposite the first surface. A plurality of openings is defined in the first surface and the second surface. The manifold is coupled to the fuel cell and the heat exchanger such that the first surface contacts the fuel cell and the second surface contacts the heat exchanger. The manifold is coupled to the air inlet pipe, the fuel inlet pipe, the air outlet pipe, and the fuel outlet pipe.

### BACKGROUND

The field of the disclosure relates generally to fuel cell modules and, more particularly, to fuel cell modules including heat exchangers and methods of operation thereof.

Fuel cells are electrochemical energy conversion devices that have demonstrated a potential for relatively high efficiency and low pollution in power generation. A fuel cell generally provides a direct current (DC) which is converted to alternating current (AC) through an inverter. The DC or AC voltage is used to power motors, lights, and any number of electrical devices and systems. Fuel cells operate in stationary, semi-stationary, or portable applications.

Certain fuel cells, such as solid oxide fuel cells (SOFCs), operate in large-scale power systems that provide electricity to satisfy industrial and municipal needs. Others are useful for smaller portable applications such as powering cars. Other common types of fuel cells include phosphoric acid (PAFC), molten carbonate (MCFC), and proton exchange membrane (PEMFC), all generally named after their electrolytes.

A fuel cell produces electricity by electrochemically combining a fuel and an oxidant across an ionic conducting layer. This ionic conducting layer, also labeled the electrolyte of the fuel cell, is a liquid or solid. Fuel cells are typically amassed in electrical series in an assembly of fuel cells to produce power at useful voltages or currents. Therefore, interconnect structures are used to connect or couple adjacent fuel cells in series or parallel to form a fuel cell stack. In general, components of a fuel cell include the electrolyte, an anode, and a cathode. The reactions that produce electricity generally take place at the anode and cathode where a catalyst is typically disposed to speed the reactions. The anode and cathode are constructed to include channels and porous layers to increase the surface area for the chemical reactions to occur. The electrolyte carries electrically charged particles between the anode and cathode and is otherwise substantially impermeable to both fuel and oxidant.

Piping components, such as pipes, valves, and joint connectors, are coupled to the fuel cell to channel fluids, such as the fuel, oxidant, and byproduct, into and away from the fuel cell. Sometimes heat exchangers are used to heat or cool the fluid. For example, in some systems, a plurality of fuel cells are coupled to a central heat exchanger and fluid is separately channeled from the central heat exchanger to each fuel cell. As a result, numerous piping components extend between the central heat exchanger and the plurality of fuel cells. Additionally, the productivity of all the fuel cells coupled to the central heat exchanger is affected when the central heat exchanger is shut down for maintenance and service.

Some of the fluids channeled by the piping components have relatively high temperatures, e.g., temperatures greater than 600° C. However, high temperature piping components, which are required to handle the high temperature fluids, add cost and complexity to the assembly and operation of the fuel cell. Additionally, some materials required to handle the high temperature fluids are incompatible with the fuel cell. For example, some materials, such as stainless steel, cause chromium vapor poisoning of the cathode in the fuel cell. Moreover, as the piping components are warmed by the high temperature fluids, the piping components expand, i.e., creep, which affects the integrity of the piping components, especially the joint connectors. Additionally, heat is lost from the high temperature fluids to the surrounding environment, which decreases the efficiency of the fuel cell.

### BRIEF DESCRIPTION

In one aspect, a fuel cell block for use in a fuel cell module includes a fuel cell and a heat exchanger coupled to the fuel cell. The heat exchanger includes a first heat exchange component, a second heat exchange component, and a casing defining an interior space. An air inlet pipe channels air to the fuel cell and at least partially extends through the interior space. The first exchange component is configured to increase the temperature of the air in the air inlet pipe. A fuel inlet pipe channels fuel to the fuel cell and at least partially extends through the interior space. The second exchange component is configured to increase the temperature of the fuel in the fuel inlet pipe. An air outlet pipe channels air away from the fuel cell and at least partially extends through the interior space. A fuel outlet pipe channels fuel away from the fuel cell and at least partially extends through the interior space. A manifold includes a first surface and a second surface opposite the first surface. A plurality of openings is defined in the first surface and the second surface. The manifold is coupled to the fuel cell and the heat exchanger such that the first surface contacts the fuel cell and the second surface contacts the heat exchanger. The manifold is coupled to the air inlet pipe, the fuel inlet pipe, the air outlet pipe, and the fuel outlet pipe.

In another aspect, a fuel cell module includes at least one fuel cell block. The at least one fuel cell block includes a fuel cell and a heat exchanger coupled to the fuel cell. The heat exchanger includes a first heat exchange component, a second heat exchange component, and a casing defining an interior space. The fuel cell module further includes at least one pipe for channeling fluid to the fuel cell. The at least one pipe at least partially extends through the interior space. The heat exchanger is configured to raise the temperature of the fluid to a temperature in a range between about 600° (Celsius) C. and about 800° C. A manifold includes a first surface and a second surface opposite said first surface. The manifold is coupled to the fuel cell and the heat exchanger such that the first surface contacts the fuel cell and the second surface contacts the heat exchanger. The at least one pipe is coupled to the manifold.

In yet another aspect, a method of channeling fluid through a fuel cell module is provided. The fuel cell module includes a fuel cell block. The method includes channeling a first fluid to the fuel cell block. The fuel cell block includes a fuel cell, a heat exchanger, and a manifold. The heat exchanger includes a casing defining an interior space. The manifold includes a first surface and a second surface opposite the first surface. A first opening and a second opening are defined in the first surface and the second surface. The manifold is coupled to the heat exchanger and to the fuel cell such that first opening and the second opening are in fluid connection with the fuel cell. The method further includes channeling the first fluid through the interior space. The first fluid is channeled through the first opening and into the fuel cell. A second fluid is channeled out of the fuel cell and through the second opening. The second fluid is channeled through the interior space. Heat is transferred from the second fluid to the first fluid as the fluids are channeled through the interior space. The heat exchanger is configured to raise the temperature of the first fluid to a temperature in a range between about 600° C. and about 800° C. The heat exchanger includes a first heat exchange component and a second heat exchange component.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of fluid flow through an exemplary power generation system;

FIG. 2 is a perspective view of an exemplary fuel cell module;

FIG. 3 is a perspective view of an exemplary fuel cell block of the fuel cell module shown in FIG. 2.

FIG. 4 is a perspective view of a portion of the fuel cell block shown in FIG. 3; and

FIG. 5 is a plan view of an exemplary manifold of the fuel cell module shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The fuel cell modules described herein include a heat exchanger to increase the efficiency and reduce the cost of generating electric power using the fuel cell modules. In particular, the embodiments described herein reduce the high temperature piping components required to channel fluids through the fuel cell module. The embodiments described herein also facilitate controlling fluid flow through the fuel cell module. Additionally, the fuel cell modules include a manifold that facilitates coupling the piping components and heat exchanger to fuel cells. Also, the heat exchanger described herein increases the efficiency of fluid heat transfer in the fuel cell module.

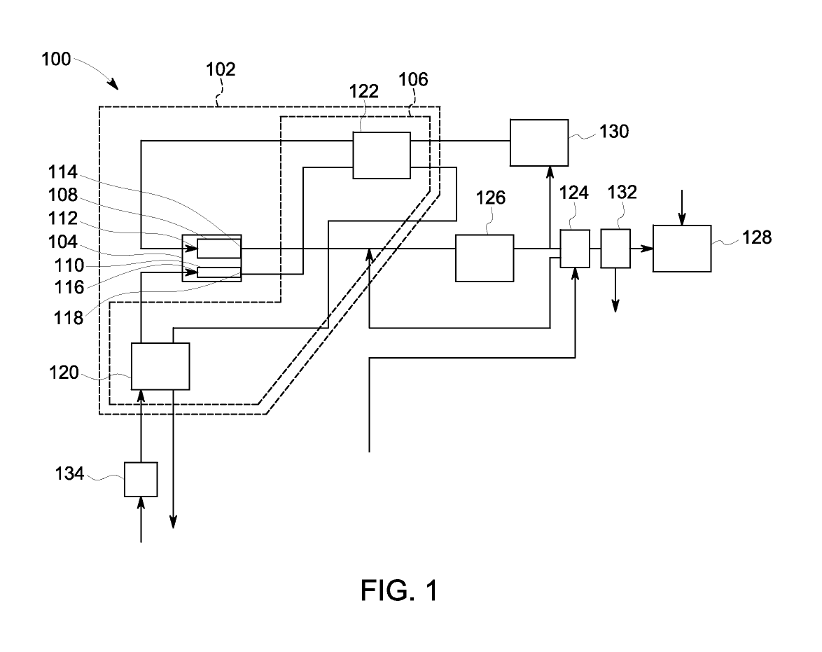

FIG. 1 is a schematic view of an exemplary electric power generation system 100 that includes a fuel cell module 102. Fuel cell module 102 includes a fuel cell 104 and an integrated heat exchanger 106. Fuel cell 104 is one of a solid oxide fuel cell (SOFC) and a molten carbonate fuel cell (MCFC). Fuel cell 104 generates direct current (DC) electric power by electrochemically combining a fuel and an oxidant (both discussed further below) across an ionic conducting layer (not shown). The ionic conducting layer, i.e., an electrolyte of fuel cell 104, is a liquid or solid. In some embodiments, fuel cell 104 is positioned in electrical series in an assembly of fuel cells 104 (only one shown in FIG. 1) to produce power at useful voltages or currents.

In the exemplary embodiment, fuel cell 104 includes the electrolyte, an anode 108, and a cathode 110. The electrochemical reactions that produce DC electricity generally take place at anode 108 and cathode 110 where a catalyst (not shown) is disposed to speed the reactions. Anode 108 and cathode 110 include channels and porous layers (neither shown) to increase the surface area for the chemical reactions to occur. The electrolyte carries electrically charged particles from one of anode 108 and cathode 110 to the other and is otherwise substantially impermeable to both fuel and oxidant. To facilitate fuel flow through anode 108, anode 108 includes an inlet 112 and an outlet 114. Likewise, cathode 110 includes an inlet 116 and an outlet 118. Anode 108 discharges a tail gas stream from anode outlet 114 that includes water, hydrogen, carbon monoxide (CO), carbon dioxide (CO₂), and unreacted fuel, if any.

In the exemplary embodiment, integrated heat exchanger 106 is coupled to fuel cell 104. Integrated heat exchanger 106 includes a first heat exchange component 120 and a second heat exchange component 122. First heat exchange component 120 is coupled in flow communication with fuel cell cathode inlet 116 and fuel cell cathode outlet 118 such that first heat exchange component 120 removes heat from fluid exhausted from fuel cell cathode and transfers heat to fluid that is channeled to fuel cell cathode inlet 116. Second heat exchange component 122 is coupled in flow communication with fuel cell cathode outlet 118 and fuel cell anode inlet 112 such that second heat exchange component 122 removes heat from fluid exhausted from fuel cell cathode outlet 118 and transfers heat to fluid that is channeled into fuel cell anode inlet 112. In the exemplary embodiment, first heat exchange component 120 is an air-to-air heat exchange component and second heat exchange component 122 is an air-to-fuel heat exchange component. In alternative embodiments, first heat exchange component 120 and second heat exchange component 122 are any heat exchange components that enable integrated heat exchanger 106 to function as described herein. In addition, in some embodiments, integrated heat exchanger 106 includes any number of heat exchange components that enable integrated heat exchanger 106 to function as described herein. For example, in some embodiments, integrated heat exchanger 106 includes at least one fuel-to-fuel heat exchange component.

Power generation system 100 also includes a fuel preheater 124 coupled in flow communication with anode outlet 112. Fuel preheater 124 is coupled in flow communication with a carbonaceous, i.e., hydrocarbon fuel source (not shown) that, in the exemplary embodiment, channels natural gas to fuel preheater 124. In alternative embodiments, any fuel is used that enables operation of power generation system 100 and fuel cell 104 as described herein.

Power generation system 100 further includes a hydrocarbon fuel reformer 126 coupled to fuel cell anode outlet 114 and fuel preheater 124. Hydrocarbon fuel reformer 126 converts a fuel stream including entrained tail gas stream to a hot reformed fuel stream with entrained carbon dioxide (CO₂). A combustion engine 128 is coupled in flow communication with hydrocarbon fuel reformer 126. The hot reformed fuel stream is channeled to combustion engine 128. In the exemplary embodiment, combustion engine 128 includes a reciprocating 4-stroke engine. In alternative embodiments, combustion engine 128 includes, for example, without limitation, a reciprocating 2-stroke engine, an opposed piston 2-stroke engine, and/or a gas turbine engine. In some embodiments, combustion engine 128 is mechanically coupled to an electric power generator and/or other load, e.g., without limitation, a pump and a compressor. A fuel heat exchanger 130 is coupled to hydrocarbon fuel reformer 126 such that fuel heat exchanger 130 warms a portion of fuel that is channeled from hydrocarbon fuel reformer 126 to fuel cell anode inlet 112.

In the exemplary embodiment, power generation system 100 further includes a water dehydrator or cooler 132 and a compressor 134. In alternative embodiments, cooler 132 and compressor 134 are omitted. In the exemplary embodiment, cooler 132 is coupled to fuel preheater 124 and lowers the temperature of fuel channeled from fuel preheater 124 towards combustion engine 128 such that water in the fuel condenses and is extracted. Compressor 134 is coupled to fuel cell module 102 and facilitates fluid moving through fuel cell module 102. In alternative embodiments, power generation system 100 includes any components coupled in any manner that enables power generation system 100 to function as described herein. For example, in some embodiments, power generation system 100 includes additional heat exchangers and fuel reformers. Additionally, in some embodiments, some components of power generation system 100 are coupled in parallel and/or in series.

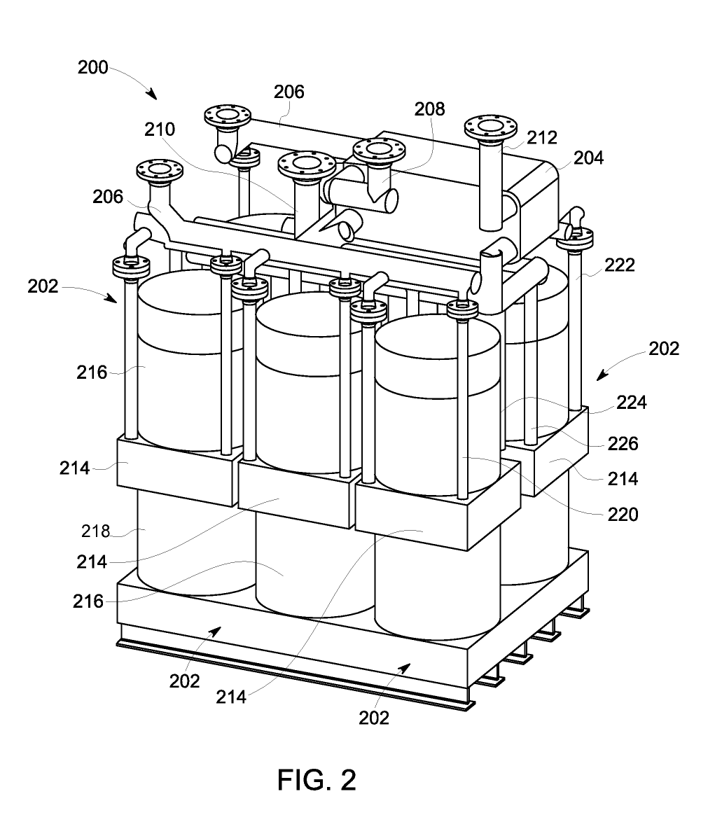

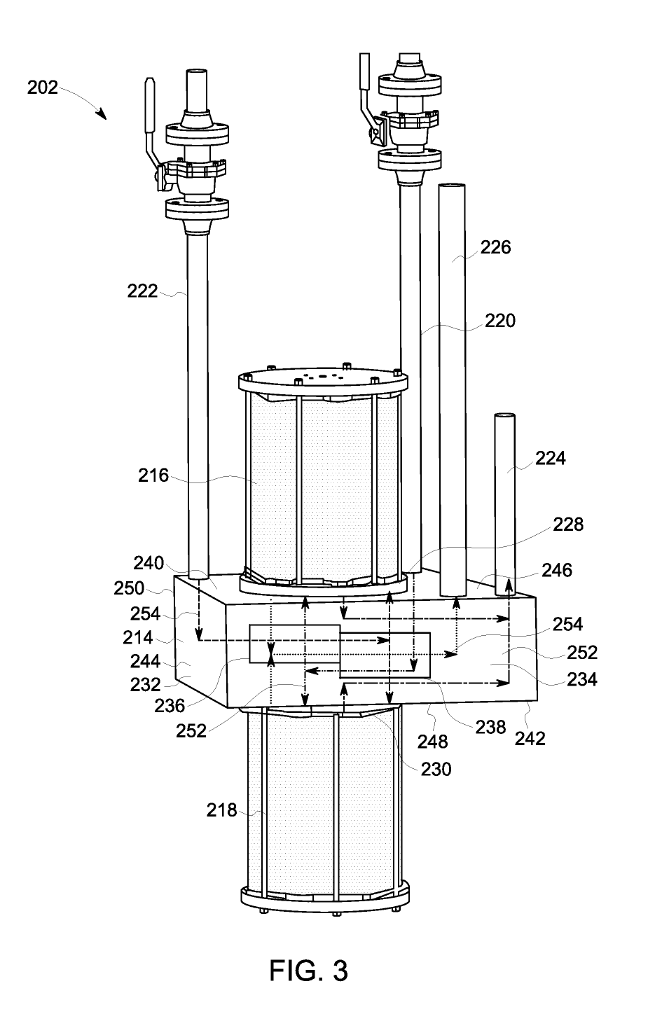

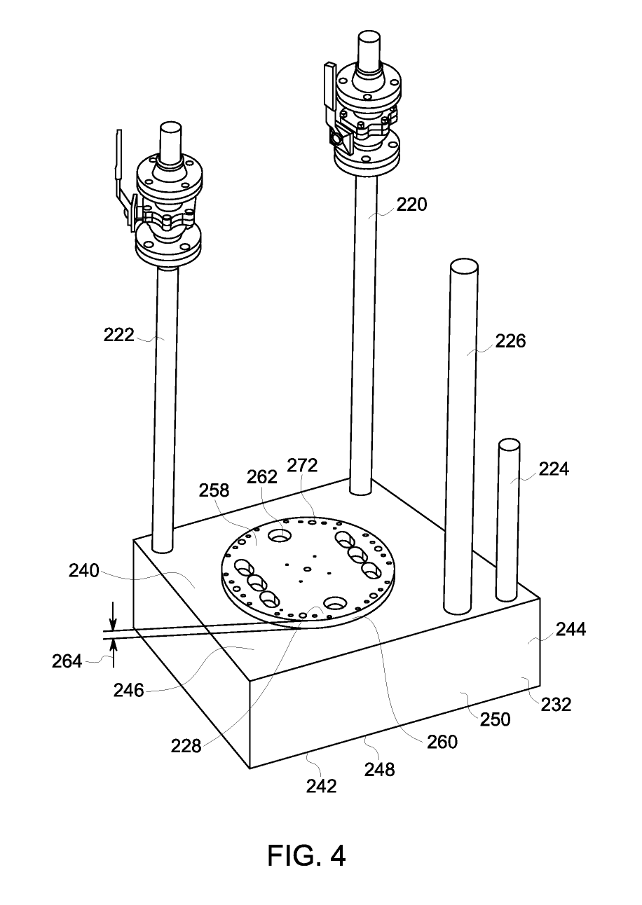

FIG. 2 is a perspective view of a fuel cell module 200 for use in power generation system 100. FIGS. 3 and 4 are perspective views of portions of fuel cell module 200. Fuel cell module 200 includes at least one fuel cell block 202, an air preheater 204, fuel inlet header 206, air inlet header 208, fuel outlet header 210, and air outlet header 212. Each fuel cell block 202 includes an integrated heat exchanger 214, a first fuel cell stack 216, a second fuel cell stack 218, a fuel inlet pipe 220, an air inlet pipe 222, a fuel outlet pipe 224, an air outlet pipe 226, an upper manifold 228, and a lower manifold 230. In alternative embodiments, fuel cell block 202 includes any number of fuel cell stacks 216, 218 and integrated heat exchangers 214 that enable fuel cell module 200 to function as described herein.

In the exemplary embodiment, each fuel cell block 202 has a power generation capacity defined as the amount of power generated by fuel cell block 202 during operation of fuel cell module 200. In some embodiments, each fuel cell block 202 has a power generation capacity in a range between about 1 kilowatt (kW) and about 500 kW. In further embodiments, each fuel cell block 202 has a power generation capacity in a range between about 25 kilowatts (kW) and about 250 kW. In some embodiments, each fuel cell block 202 has a power generation capacity of approximately 200 kW.

Fuel cell module 200 has an overall power generation capacity that is the sum of the power generation capacities of fuel cell blocks 202. In some embodiments, fuel cell module 200 has an overall power generation capacity of between about 25 kW and about 1,500 kW. In further embodiments, fuel cell module 200 has an overall power generation capacity of between about 150 kW and about 1,250 kW. In the exemplary embodiment, fuel cell module 200 includes six fuel cell blocks 202 and each fuel cell block 202 has a power generation capacity of approximately 167 kW. Accordingly, fuel cell module 200 has an overall power generation capacity of approximately 1,000 kW. In alternative embodiments, fuel cell module 200 includes any number of fuel cell blocks 202 having any power generation capacities that enable fuel cell module 200 to function as described herein.

In the exemplary embodiment, first fuel cell stack 216 and second fuel cell stack 218 each include a plurality of fuel cells 104 (shown in FIG. 1) including an electrolyte and two electrodes. First fuel cell stack 216 and second fuel cell stack 218 produce electricity by electrochemically combining a fuel and an oxidant across an ionic conducting layer. In the exemplary embodiment, first fuel cell stack 216 and second fuel cell stack 218 include fuel cells 104 that are solid oxide fuel cells. In alternative embodiments, first fuel cell stack 216 and second fuel cell stack 218 include any type of fuel cells that enables fuel cell module 200 to function as described herein. In the exemplary embodiment, first fuel cell stack 216 and second fuel cell stack 218 are coupled to integrated heat exchanger 214 on opposing sides of integrated heat exchanger 214. In alternative embodiments, first fuel cell stack 216 and second fuel cell stack 218 are coupled to integrated heat exchanger 214 in any manner that enables fuel cell block 202 to function as described herein.

In the exemplary embodiment, integrated heat exchanger 214 includes a casing 232 defining an interior space 234, a first heat exchange component 236, and a second heat exchange component 238. In reference to the orientation shown in FIG. 3, casing 232 includes a top wall 240, a bottom wall 242, and a sidewall 244 extending between top wall 240 and bottom wall 242. Each of top wall 240, bottom wall 242, and sidewall 244 includes a respective outer surface 246, 248, 250. In alternative embodiments, integrated heat exchanger 214 includes any number of walls and surfaces that enable integrated heat exchanger 214 to function as described herein.

Fluids, such as fuel 252 and air 254, are channeled through fuel cell module 200 during operation of fuel cell module 200. Specifically, fluids are channeled through fuel inlet header 206, air inlet header 208, fuel outlet header 210, air outlet header 212, fuel inlet pipe 220, air inlet pipe 222, fuel outlet pipe 224, and air outlet pipe 226. As best seen in FIG. 3, each of fuel inlet pipe 220, air inlet pipe 222, fuel outlet pipe 224, and air outlet pipe 226 channel fluid to and from first fuel cell stack 216 and second fuel cell stack 218.

Air preheater 204 is coupled to air inlet header 208 upstream of integrated heat exchanger 214 and to air outlet pipe 226 downstream of integrated heat exchanger 214. Air preheater 204 removes heat from air 254 in air outlet pipe 226 and transfers heat to air 254 in air inlet pipe 222. In the exemplary embodiment, prior to air inlet pipe 222 channeling air 254 through interior space 234, air preheater 204 increases the temperature of air 254 in air inlet pipe 222 to a temperature in a range between about 100° Celsius (C.) (212° Fahrenheit (F.)) and about 600° C. (1112° F.).

In operation, air 254 is channeled through air inlet header 208 into air inlet pipe 222 for delivery to fuel cell block 202. Each air inlet pipe 222 extends at least partially into interior space 234. Within interior space 234, air inlet pipe 222 branches into separate sections for delivering air 254 to first fuel cell stack 216 and second fuel cell stack 218. In alternative embodiments, air inlet pipe 222 feeds air 254 to any number of fuel cell stacks 216, 218 that enable fuel cell module 200 to function as described herein. In the exemplary embodiment, air inlet pipe 222 is warmed by first heat exchange component 236 such that the temperature of air 254 channeled through air inlet pipe 222 is increased. In the exemplary embodiment, on the exterior of integrated heat exchanger 214, air 254 in air inlet pipe 222 is maintained at a temperature less than 600° C. In interior space 234, first heat exchange component 236 increases the temperature of air 254 in air inlet pipe 222 to a temperature in a range between about 600° C. (1112° F.) and about 800° C. (1472° F.). As a result, high temperature piping components are only required for the portions of air inlet pipe 222 within interior space 234. High temperature piping components are components designed and manufactured for channeling fluid having relatively high temperatures, i.e., temperatures greater than about 600° C. (1112° F.).

During operation of fuel cell module 200, fuel 252 is channeled through fuel inlet header 206 into fuel inlet pipe 220 for delivery to fuel cell block 202. Each fuel inlet pipe 220 extends at least partially into interior space 234. In the exemplary embodiment, within interior space 234, fuel inlet pipe 220 branches into separate sections for delivering fuel to first fuel cell stack 216 and second fuel cell stack 218. In alternative embodiments, fuel inlet pipe 220 feeds fuel to any number of fuel cell stacks 216, 218 that enable fuel cell module 200 to function as described herein. In the exemplary embodiment, fuel inlet pipe 220 is warmed by second heat exchange component 238 such that the temperature of fluid channeled through fuel inlet pipe 220 is increased. In the exemplary embodiment, on the exterior of integrated heat exchanger 214, fluid fuel inlet pipe 220 is maintained at a temperature less than 600° C. In interior space 234, second heat exchange component 238 facilitates increasing the temperature of fluid in fuel inlet pipe 220 to a temperature in a range between about 600° C. (1112° F.) and about 800° C. (1472° F.). As a result, high temperature piping components are only required for the portions of fuel inlet pipe 220 within interior space 234.

In the exemplary embodiment, fuel is exhausted from first fuel cell stack 216 and second fuel cell stack 218 into fuel outlet pipe 224, which extends at least partially into interior space 234. Fuel outlet pipe 224 channels fuel out of interior space 234 and to fuel outlet header 210. Air is exhausted from first fuel cell stack 216 and second fuel cell stack 218 into air outlet pipe 226, which extends at least partially into interior space 234. Air outlet pipe 226 channels air out of interior space 234 and to air outlet header 212. Inside interior space 234, first heat exchange component 236 facilitates heat exchange between air outlet pipe 226 and air inlet pipe 222 and second heat exchange component 238 facilitates heat exchange between air outlet pipe 226 and air inlet pipe 222. As a result, fluid in air outlet pipe 226 decreases in temperature as fluid is channeled through interior space 234. In the exemplary embodiment, the temperature of fluid in air outlet pipe 226 is lowered such that the temperature is less than about 600° C. (1112° F.) prior to exiting interior space 234. As a result, high temperature piping components are only required for the portions of air outlet pipe 226 within interior space 234.

In the exemplary embodiment, in reference to the orientation shown in FIG. 3, upper manifold 228 is positioned above integrated heat exchanger 214 and lower manifold 230 is positioned below integrated heat exchanger 214. Upper manifold 228 is positioned between and coupled to integrated heat exchanger 214 and first fuel cell stack 216. Lower manifold 230 is positioned between and coupled to integrated heat exchanger 214 and second fuel cell stack 218. In alternative embodiments, the components of fuel cell module 200 are positioned in any manner that enables fuel cell module 200 to function as described herein. Additionally, in alternative embodiments, fuel cell module 200 includes any number of manifolds that enable fuel cell module 200 to function as described herein. In the exemplary embodiment, upper manifold 228 and lower manifold 230 are substantially identical. Accordingly, additional description of lower manifold 230 is unnecessary since upper manifold 228 is described in detail below. In alternative embodiments, lower manifold 230 is different from upper manifold 228. In some embodiments, upper manifold 228 and/or lower manifold 230 are omitted.

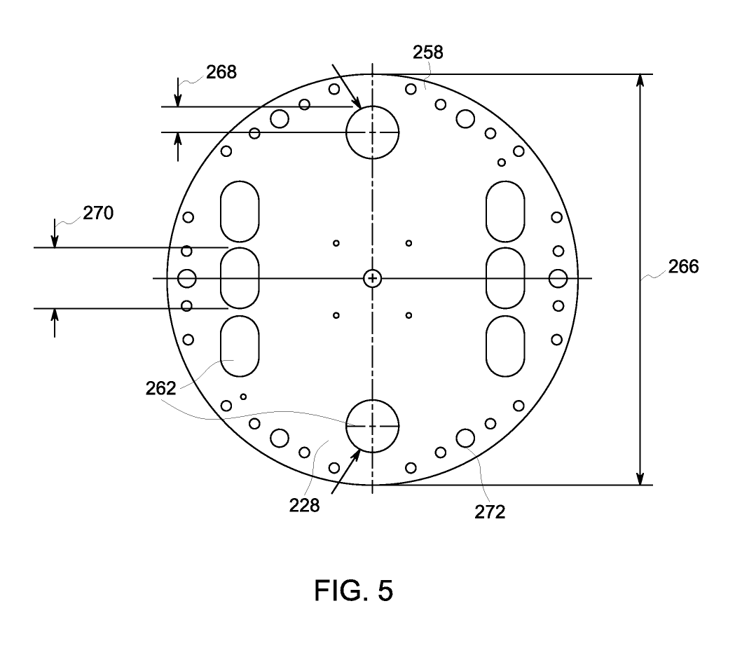

FIG. 5 is a plan view of upper manifold 228. Upper manifold 228 includes a first surface 258, a second surface 260 opposite first surface 258, and a plurality of openings 262. Openings 262 are defined in and extend between first surface 258 and second surface 260 to provide a channel for fluid flow through upper manifold 228. Upper manifold 228 has a thickness 264 measured between first surface 258 and second surface 260. In some embodiments, thickness 264 is in a range between about 2 millimeters (mm) (0.1 inches (in.)) and about 400 mm (16 in.). In the exemplary embodiment, thickness 264 is approximately 19 mm (0.75 in.). Upper manifold 228 has a maximum width 266 defined between the lateral edges of upper manifold 228. In the exemplary embodiment, upper manifold 228 has a circular shape including a diameter equal to maximum width 266. In some embodiments, maximum width 266 is in a range between about 254 mm (10 in.) and about 1270 mm (50 in.). In the exemplary embodiment, maximum width 266 is approximately 406 mm (16 in.). In alternative embodiments, upper manifold 228 is any shape and size that enables upper manifold 228 to function as described herein.

In the exemplary embodiment, each of openings 262 has an at least partially circular shape with a radius 268. In some embodiments, radius 268 is in a range between about 2.5 mm (0.1 in.) and about 254 mm (10 in.). In the exemplary embodiment, radius 268 is approximately 25 mm (1 in.). Some of openings 262 are elongated to form a slot-like shape with a length 270. In some embodiments, length 270 is in a range between about 25 mm (1 in.) and about 254 mm (10 in.). In the exemplary embodiment, length 270 is approximately 64 mm (2.5 in.). In alternative embodiments, openings 262 are any shape and size that enable upper manifold 228 to function as described herein. In the exemplary embodiment, upper manifold 228 further includes a plurality of holes 272 to facilitate coupling upper manifold 228 to other components.

In reference back to FIGS. 3 and 4, upper manifold 228 is coupled to first fuel cell stack 216 such that first surface 258 contacts first fuel cell stack 216 and second surface 260 contacts integrated heat exchanger 214. Fuel inlet pipe 220, air inlet pipe 222, fuel outlet pipe 224, and air outlet pipe 226 are coupled to upper manifold 228 adjacent openings 262. As a result, fluid in fuel inlet pipe 220 and air inlet pipe 222 is channeled through openings 262 into first fuel stack 216. Additionally, fluid in first fuel stack 216 is channeled through openings 262 into fuel outlet pipe 224 and air outlet pipe 226.

Referring to FIGS. 1-3, a method of channeling fluid 252, 254 through fuel cell module 200 includes channeling fluid 252, 254 through fuel cell block 200. In some embodiments, fluid 252, 254 is separately channeled through a plurality of fuel cell blocks 202 coupled together to form fuel cell module 200. In the exemplary embodiment, fluid 252, 254 is channeled through interior space 234. In some embodiments, fluid 252, 254 is channeled through air outlet header 212, fuel inlet pipe 220, air inlet pipe 222, fuel outlet pipe 224, and air outlet pipe 226, which extend at least partially through interior space 234. In the exemplary embodiment, fluid 252, 254 is channeled through openings 262 and into fuel cell 104. Fluid 252, 254 is channeled out of fuel cell 104 through openings 262 and through interior space 234. As fluids 252, 254 are channeled through interior space 234, heat is removed from fluid 252, 254 channeled out of fuel cell 104 and is transferred to fluid 252, 254 that is channeled towards fuel cell 104. Integrated heat exchanger 214 is configured to raise the temperature of fluid 252, 254 to a temperature in a range between about 600° C. and about 800° C. In some embodiments, fluid 252, 254 is maintained at a temperature in a range between about 100° C. and about 600° C. prior to channeling fluid 252, 254 through interior space 234.

The above described fuel cell modules include a heat exchanger to increase the efficiency and reduce the cost of generating electric power using the fuel cell modules. In particular, the embodiments described herein reduce the high temperature piping components required to channel fluids through the fuel cell module. The embodiments described herein also facilitate controlling fluid flow through the fuel cell module. Additionally, the fuel cell modules include a manifold that facilitates coupling the piping components and heat exchanger to fuel cells. Also, the heat exchanger described herein increases the efficiency of fluid heat transfer in the fuel cell module.

An exemplary technical effect of the methods, systems, and apparatus described herein includes at least one of: (a) increasing the operating efficiency of fuel cell modules; (b) decreasing the time and cost required to maintain and repair fuel cell modules; (c) reducing the cost of assembling and operating fuel cell modules; (d) reducing the amount of high temperature piping components required in fuel cell modules; (e) controlling the pressure drop of fluid through fuel cell modules; and (f) reducing the complexity of piping connections in the fuel cell modules.

Exemplary embodiments of fuel cell modules that include an integrated heat exchanger are described above in detail. The fuel cell modules that include an integrated heat exchanger, and methods of operating such systems and devices are not limited to the specific embodiments described herein, but rather, components of systems and/or steps of the methods may be utilized independently and separately from other components and/or steps described herein. For example, the methods may also be used in combination with other systems, and are not limited to practice with only the fuel cell modules, fuel cell systems, and methods as described herein. Rather, the exemplary embodiment can be implemented and utilized in connection with many other fuel cell applications that are currently configured to receive and accept fuel cells, e.g., and without limitation, distributed generation facilities in remote areas and industrial facilities.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel cell block for use in a fuel cell module, said fuel cell block comprising:
a fuel cell;
a heat exchanger coupled to said fuel cell, said heat exchanger comprising a first heat exchange component, a second heat exchange component, and a casing defining an interior space;
an air inlet pipe for channeling air to said fuel cell, said air inlet pipe at least partially extending through the interior space, said first exchange component configured to increase the temperature of the air in said air inlet pipe;
a fuel inlet pipe for channeling fuel to said fuel cell, said fuel inlet pipe at least partially extending through the interior space, said second heat exchange component configured to increase the temperature of the fuel in said fuel inlet pipe;
an air outlet pipe for channeling air away from said fuel cell, said air outlet pipe at least partially extending through the interior space;
a fuel outlet pipe for channeling fuel away from said fuel cell, said fuel outlet pipe at least partially extending through the interior space; and
a manifold comprising a first surface and a second surface opposite said first surface, a plurality of openings defined in said first surface and said second surface, said manifold coupled to said fuel cell and said heat exchanger such that said first surface contacts said fuel cell and said second surface contacts said heat exchanger, said manifold coupled to said air inlet pipe, said fuel inlet pipe, said air outlet pipe, and said fuel outlet pipe.

2. The fuel cell block in accordance with claim 1, wherein said fuel cell is a first fuel cell, said fuel cell block further comprising a second fuel cell coupled to said heat exchanger.

3. The fuel cell block in accordance with claim 2, wherein said manifold is a first manifold, said fuel cell block further comprising a second manifold coupled to said second fuel cell and said heat exchanger.

4. The fuel cell block in accordance with claim 3, wherein said first fuel cell, said second fuel cell, and said heat exchanger are aligned in a vertical direction, said heat exchanger positioned between said first fuel cell and said second fuel cell.

5. The fuel cell block in accordance with claim 4, wherein said casing comprises a top wall, a bottom wall, and a sidewall extending between the top wall and the side wall, said first manifold coupled to said top wall and said second manifold coupled to said bottom wall.

6. The fuel cell block in accordance with claim 1, wherein said manifold has a maximum width in a range between about 254 millimeters (mm) and about 1270 mm.

7. The fuel cell block in accordance with claim 6, wherein said manifold has a thickness measured between said first surface and said second surface, said thickness in a range between about 2 mm and about 400 mm.

8. The fuel cell block in accordance with claim 1, wherein said fuel cell is coupled to a plurality of fuel cells to form a fuel cell stack.

9. A fuel cell module comprising:
at least one fuel cell block comprising:
a fuel cell;
a heat exchanger coupled to said fuel cell, said heat exchanger comprising a first heat exchange component, a second heat exchange component, and a casing defining an interior space;
at least one pipe for channeling fluid to said fuel cell, said at least one pipe at least partially extending through the interior space; and
a manifold comprising a first surface and a second surface opposite said first surface, said manifold coupled to said fuel cell and said heat exchanger such that said first surface contacts said fuel cell and said second surface contacts said heat exchanger, said at least one pipe coupled to said manifold.

10. The fuel cell module in accordance with claim 9, wherein said at least one fuel cell block comprises a plurality of said fuel cell blocks.

11. The fuel cell module in accordance with claim 10, wherein each fuel cell block of said plurality of said fuel cell blocks further comprises a plurality of fuel cells coupled to said fuel cell.

12. The fuel cell module in accordance with claim 11, wherein said heat exchanger is configured to raise the temperature of the fluid to a temperature in a range between about 600° C. and about 800° C.

13. The fuel cell module in accordance with claim 9, wherein said at least one pipe comprises an air inlet pipe and a fuel inlet pipe, each of said air inlet pipe and said fuel inlet pipe at least partially extending through the interior space, said first heat exchange component configured to raise the temperature of fluid in said air inlet pipe and said second heat exchange component configured to raise the temperature of fluid in said fuel inlet pipe.

14. The fuel cell module in accordance with claim 13, further comprising an air outlet pipe and a fuel outlet pipe, said air outlet pipe at least partially extending through the interior space, at least one of said first heat exchange component and said second heat exchange component configured to remove heat from the fluid in said air outlet pipe.

15. A method of channeling fluid through a fuel cell module including a fuel cell block, said method comprising:
channeling a first fluid to the fuel cell block, the fuel cell block including a fuel cell, a heat exchanger, and a manifold, the heat exchanger including a casing defining an interior space, the manifold including a first surface and a second surface opposite the first surface, a first opening and a second opening defined in the first surface and the second surface, the manifold coupled to the heat exchanger and to the fuel cell such that the first opening and the second opening are in fluid connection with the fuel cell;
channeling the first fluid through the interior space;
channeling the first fluid through the first opening and into the fuel cell;
channeling a second fluid out of the fuel cell and through the second opening;
channeling the second fluid through the interior space; and
transferring heat from the second fluid to the first fluid as the fluids are channeled through the interior space, the heat exchanger configured to raise the temperature of the first fluid to a temperature in a range between about 600° C. and about 800° C., the heat exchanger including a first heat exchange component and a second heat exchange component.

16. The method in accordance with claim 15, wherein the fuel cell is a first fuel cell and the manifold is a first manifold, the method further comprising channeling a third fluid through the interior space and through a second manifold into a second fuel cell, the second manifold coupled to the heat exchanger and to the second fuel cell.

17. The method in accordance with claim 16 further comprising channeling a third fluid through the interior space and channeling a fourth fluid through the interior space.

18. The method in accordance with claim 17 further comprising transferring heat from the fourth fluid to the third fluid as the fluids are channeled through the interior space.

19. The method in accordance with claim 15 further comprising maintaining the first fluid at a temperature in a range between about 100° C. and about 600° C. prior to channeling the first fluid through the interior space.

20. The method in accordance with claim 19 wherein channeling the first fluid through the interior space comprises channeling the first fluid through a pipe extending at least partially through the interior space.
